(19) United States
(12) Patent Application Publication
(10) Pub. No.: US 2006/0198582 A1
(43) Pub. Date: Sep. 7, 2006

(54) Photodetection device and light source module

(76) Inventor: Motoki Kakui, Yokohama-shi (JP)

Correspondence Address: MCDERMOTT WILL & EMERY LLP, 600 13TH STREET, N.W., WASHINGTON, DC, 20005-3096, US

(21) Appl. No.: 11/364,364

(22) Filed: Mar. 1, 2006

(30) Foreign Application Priority Data
Mar. 1, 2005 (JP) P2005-056409

(51) Int. Cl. G02B 6/26

(52) U.S. Cl. 385/48

(57) ABSTRACT

There is disclosed a photodetection device comprising: a photodetector having detection sensitivity at a first wavelength; a first optical fiber propagating light in a plurality of modes at the first wavelength, the first optical fiber having an entrance end on which light at the first wavelength falls; and a second optical fiber propagating light in a plurality of modes at the first wavelength, the second optical fiber having a product of a core diameter and a numerical aperture at the first wavelength that is greater than a product of a core diameter and a numerical aperture at the first wavelength of the first optical fiber, the second optical fiber having one end and another end, the second optical fiber being optically coupled to the first optical fiber at the middle of the first optical fiber in a longitudinal direction of the first optical fiber, and the one end of the second optical fiber being optically coupled to the photodetector.

### BACKGROUND OF THE INVENTION

1. Field of the Invention

The present invention relates to a photodetection device and a light source module.

2. Related Background Art

A photodetection device is used to monitor the power of light output from a light source by diverting and extracting a part of the light output from the light source and detecting the power of the extracted light using a photodetector, for example. In this type of photodetection device, an optical fiber coupler is preferably used to divert a part of the light. Note that a photodetection device comprises a photodetector and an optical fiber coupler. A device comprising the photodetection device and a light source is known as a light source module.

An optical fiber coupler is manufactured by subjecting a first optical fiber and a second optical fiber to fusion tapering such that the first optical fiber and second optical fiber are optically coupled to each other. The light source is coupled to one end of the first optical fiber, and the photodetector is coupled to one end of the second optical fiber. In the light source module, a part of the light output from the light source is diverted to the second optical fiber by the optical fiber coupler as the light propagates through the first optical fiber. The diverted light propagates through the second optical fiber and is detected by the photodetector. On the basis of the detection result generated by the photodetector, the power of the light output from the light source is monitored.

### SUMMARY OF THE INVENTION

However, when a conventional light source module such as that described above comprises a light source which outputs light in a plurality of transverse modes, such as a light source used in processing applications and the like, the detection result generated by the photodetection device may vary even when the power of the light output from the light source is constant, and hence monitoring of the power of the light output from the light source may not be performed accurately.

The present invention has been designed in order to solve this problem, and it is an object thereof to provide a photodetection device which can monitor optical power with a greater degree of accuracy even when employed in processing applications and the like.

A photodetection device according to the present invention comprises a photodetector having detection sensitivity at a first wavelength; a first optical fiber propagating light in a plurality of modes at the first wavelength, the first optical fiber having an entrance end on which light at the first wavelength falls; and a second optical fiber propagating light in a plurality of modes at the first wavelength, the second optical fiber having a product of a core diameter and a numerical aperture at the first wavelength that is greater than a product of a core diameter and a numerical aperture at the first wavelength of the first optical fiber, the second optical fiber having one end and another end, the second optical fiber being optically coupled to the first optical fiber at the middle of the first optical fiber in a longitudinal direction of the first optical fiber, and the one end of the second optical fiber being optically coupled to the photodetector.

A light source module according to the present invention comprises the photodetection device according to the present invention described above; and a light source for emitting light of the first wavelength to the entrance end of the first optical fiber, wherein the entrance end optically opposes the one end of the second optical fiber via the connection point between the first optical fiber and the second optical fiber.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood, that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a constitutional diagram of a light source module 1 and a photodetection device 10 according to an embodiment;

FIG. 2 is a side view showing another constitutional example of the photodetection device 10 according to this embodiment; and

FIG. 3 is a side view showing another constitutional example of the photodetection device 10 according to this embodiment.

### DESCRIPTION OF THE PREFERRED EMBODIMENTS

A preferred embodiment of the present invention will be described in detail below with reference to the attached drawings. Note that in the drawings, identical elements have been allocated identical reference numerals, and duplicate description thereof has been omitted.

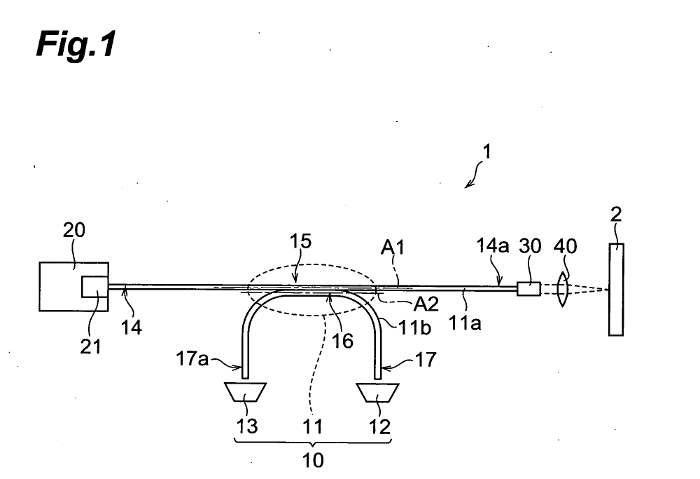

FIG. 1 is a constitutional diagram of a light source module 1 and a photodetection device 10 according to this embodiment. The light source module 1 shown in the drawing is used to process a processing subject 2 by irradiating the processing subject 2 with laser light, and comprises the photodetection device 10, a light source 20, a collimator 30, and a condenser lens 40. The photodetection device 10 comprises an optical fiber coupler 11, a photodetector 12, and a photodetector 13. The optical fiber coupler 11 is constituted by a first optical fiber 11a and a second optical fiber 11b.

The light source 20 outputs the laser light with which the processing subject 2 is irradiated. The laser light output from the light source 20 may be continuous light or pulsed light. The wavelength of the laser light output from the light source 20 is selected appropriately in accordance with the material (metal or resin, for example) of the processing subject 2, and is set in a 1 μm region, for example. The light source 20 comprises a laser medium such as an Nd-doped YAG rod or a Yb-doped fiber, and comprises an excitation light source for outputting excitation light which excites the active element (Nd, Yb, or the like) doped onto the laser medium as a laser diode, for example.

The light source 20 is optically coupled to a first end 14 of the first optical fiber 11a, and the collimator 30 is provided on a second end 14a of the first optical fiber 11a. The first optical fiber 11a inputs the laser light output from the light source 20 into the first end 14, guides the light to the second end 14a, and outputs the guided laser light to the outside through the collimator 30. The collimator 30 forms the output light into a parallel beam. The condenser lens 40 converges the laser light formed into a parallel beam by the collimator 30 and irradiates the processing surface of the processing subject 2 with the condensed light.

The first optical fiber 11a and second optical fiber 11b are optically coupled to each other through fusion tapering, and thus constitute the optical fiber coupler 11. At the connection point between the first optical fiber 11a and the second optical fiber 11b, the optical axis A1 of the first optical fiber 11a is essentially parallel to the optical axis A2 of the second optical fiber 11b. The photodetector 12 is optically coupled to a first end 17 of the second optical fiber 11b, and the photodetector 13 is optically coupled to a second end 17a of the second optical fiber 11b. A portion 16 of the second optical fiber 11b is optically coupled to a middle portion 15 in a longitudinal direction of the first optical fiber 11a.

The light source 20 is preferably a fiber laser light source comprising an amplification optical fiber 21 as an optical amplification medium. An optical waveguide extending from the amplification optical fiber 21 to the first optical fiber 11a is preferably constituted entirely by optical fiber. Note that the first optical fiber 11a may have a continuous length from the first end 14 on the light source 20 side to the second end 14a on the collimator 30 side, or may be constituted by a plurality of similar optical fibers that are connected through fusion. Similarly, the second optical fiber 11b may have a continuous length from the first end 17 on the photodetector 12 side to the second end 17a on the photodetector 13 side, or may be constituted by a plurality of similar optical fibers that are connected through fusion.

In this light source module 1, the laser light that is output from the light source 20 enters the first end 14 of the first optical fiber 11a and is guided through the first optical fiber 11a to the second end 14a of the first optical fiber 11a, from which it is emitted. The laser light is then formed into a parallel beam by the collimator 30, converged by the condenser lens 40, and emitted onto the processing surface of the processing subject 2 as condensed light. The processing subject 2 is processed through irradiation with the condensed laser light.

At this time, a part of the light that is output from the light source 20, introduced into the first end 14 of the first optical fiber 11a, and guided through the first optical fiber 11a is diverted in the optical fiber coupler 11, guided through the second optical fiber 11b, and detected by the photodetector 12. The power of the light output from the light source 20 is monitored on the basis of the detection result generated by the photodetector 12.

Further, light (reflection light or thermal radiation) that is generated when the processing subject 2 is irradiated with the laser light may occasionally enter the second end 14a of the first optical fiber 11a through the condenser lens 40 and collimator 30. A part of the light that enters the second end 14a of the first optical fiber 11a so as to be guided through the first optical fiber 11a is diverted in the optical fiber coupler 11, guided through the second optical fiber 11b, and detected by the photodetector 13. The condition in which the laser light is emitted onto the processing subject 2 is monitored on the basis of the detection result generated by the photodetector 13.

During typical laser processing, a favorable beam quality in the vicinity of the diffraction limit is often required, and therefore the number of possible propagation modes of first optical fiber 11a is preferably as low as possible. On the other hand, in order to avoid reduced output caused by damage to the end surface of the fiber or a non-linear effect in the fiber, the mode field of the first optical fiber 11a is preferably wide. To satisfy both of these conditions, the numerical aperture (NA) of the core of the first optical fiber 11a must be made as small as possible while the core diameter of the first optical fiber 11a is made as large as possible. The core diameter of the first optical fiber 11a is preferably at least 15 μm. The NA of the first optical fiber 11a is preferably not more than 0.06 (the relative refractive index difference between the core and cladding is preferably not more than 0.08%).

When the NA of the first optical fiber 11a is reduced to 0.06, the wavelength of the laser light which propagates through the first optical fiber 11a is set in a 1.06 μm region, and the core diameter of the first optical fiber 11a is not more than 14 μm, a single mode (i.e. the diffraction limit) can be maintained. However, in the case of a high-output laser processing device with a power exceeding 100 W, the core diameter of the first optical fiber 11a is preferably increased even further. Moreover, in order to prevent damage to the first optical fiber 11a itself, silica glass is preferably used as the material of the first optical fiber 11a. When an optical fiber having an NA of 0.06 is used as the first optical fiber 11a, the radiation angle in the optical axis direction is extremely small, and hence monitoring using an optical fiber connected to the side face of the first optical fiber 11a is not easy.

The optical fiber coupler 11 provided in the photodetection device 10 according to this embodiment may be realized by subjecting the two optical fibers 11a, 11b to fusion tapering, for example. Note that in this case, when optical fibers having a laser light wavelength in a 1 μm region and an NA of 0.06 are employed as the optical fibers 11a, 11b, and the ratio between the core diameter at the fused part and the thickness of the cladding part between the cores is set at 1.27, divergence monitoring of approximately 20 dB can be realized. If an optical fiber having a higher NA is used as the second optical fiber 11b, the thickness of the cladding portion can be increased, and the time required for fusion tapering can be shortened. Moreover, light guidance through the second optical fiber 11b can be performed reliably even when manufacturing conditions such as the fusion time vary.

Further, when the NA of the first optical fiber 11a is set at 0.06 and the core diameter is set at 20 ∞m to avoid a non-linear effect, the number of possible propagation modes increases to six. Note, however, that this number merely indicates the number of possible propagation modes, and does not mean that this number of modes is propagating at all times. The number of propagating modes and the optical power distribution among the modes may vary over time due to the effects on the optical fiber of stress, bending, temperature, and so on. In this case, when the number of possible propagation modes of the second optical fiber 11b is approximately equal to the number of possible propagation modes of the first optical fiber 11a, a mode that cannot be coupled may occur due to manufacturing irregularities in the optical fiber coupler 11, the aforementioned temporal variation in the propagation light of the first optical fiber 11a, and so on, and as a result, the monitored optical power ratio may vary over time.

To solve these problems, the first optical fiber 11a and second optical fiber 11b of this embodiment are each set to be capable of propagating light in a plurality of modes within a predetermined wavelength region in which the photodetectors 12, 13 possess detection sensitivity, while the product of the core diameter and numerical aperture of the second optical fiber 11b is set to be larger than the product of the core diameter and numerical aperture of the first optical fiber 11a. In other words, the number of possible propagation modes is set to be larger in the second optical fiber 11b than in the first optical fiber 11a. In so doing, optical coupling from the first optical fiber 11a to the second optical fiber 11b is stabilized. If the number of possible propagation modes in the second optical fiber 11b is set to be at least ten times larger than the number of possible propagation modes in the first optical fiber 11a, it is also possible to respond to temporal variation.

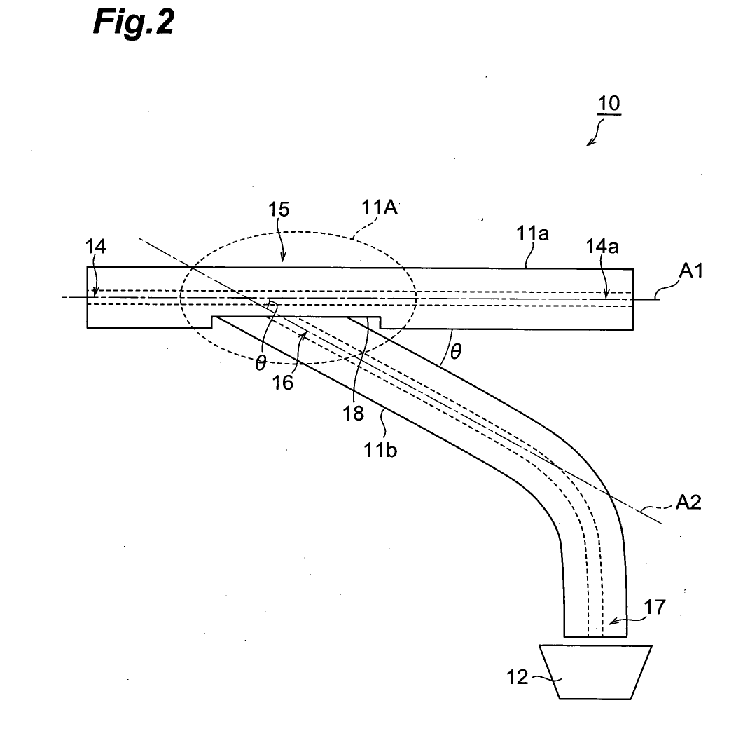

Alternatively, the photodetection device 10 according to this embodiment may be constituted as shown in FIG. 2. FIG. 2 is a side view showing another constitutional example of the photodetection device 10 according to this embodiment. In the constitution shown in the drawing, an optical fiber coupler 11A is formed by coupling the end face of the second optical fiber 11b to the side face 18 of the first optical fiber 11a. More specifically, in the optical fiber coupler 11A, a part of the side face 18 of the first optical fiber 11a is polished flat while the end face of the second optical fiber 11b is polished to a diagonal, whereupon the diagonally-polished end face of the second optical fiber 11b is optically coupled to the flat portion on the polished side face 18 of the first optical fiber 11a. The coupling method employed at this time may be adhesion using a resin or fusion through arc discharge or laser heating.

In this case, an angle θ formed by the optical axis A1 of the first optical fiber 11a and the optical axis A2 of the second optical fiber 11b is preferably held to or within a radiation angle corresponding to the NA of the first optical fiber 11a. When the NA of the first optical fiber 11a is 0.06, the angle θ is preferably held to or within ±6.90. However, when the angle θ is 6.9° or smaller, coupling, including polishing of the second optical fiber 11b, becomes difficult. When the NA of the second optical fiber 11b is larger than the NA of the first optical fiber 11a, the angle θ may be held within a radiation angle corresponding to the NA of the second optical fiber 11b. For example, when the NA of the second optical fiber 11b is 0.3, the angle θ may be no greater than 35° At the connection point between the first optical fiber 11a and the second optical fiber 11b, the optical axis A1 and the optical axis A2 intersect each other.

Note that when the second optical fiber 11b has a large number of possible propagation modes, stray light (for example, remnant components of the excitation light used in the light source 20 or the like) may be received by the photodetector 12 as well as the light propagating originally through the first optical fiber 11a. To prevent this, means such as providing the first optical fiber 11a with a complete single clad structure or providing a WDM filter for blocking excitation light and transmitting only laser oscillation light directly before the photodetector 12 are preferably employed. In this case, the WDM filter may be a dielectric multilayer filter. Typically, optical damage occurs easily in a dielectric multilayer filter, and therefore dielectric multilayer filters are avoided in laser processing applications and the like. In this case, however, light enters the filter following divergence, and hence optical damage can be avoided by optimizing the divergence ratio of the optical fiber coupler 11.

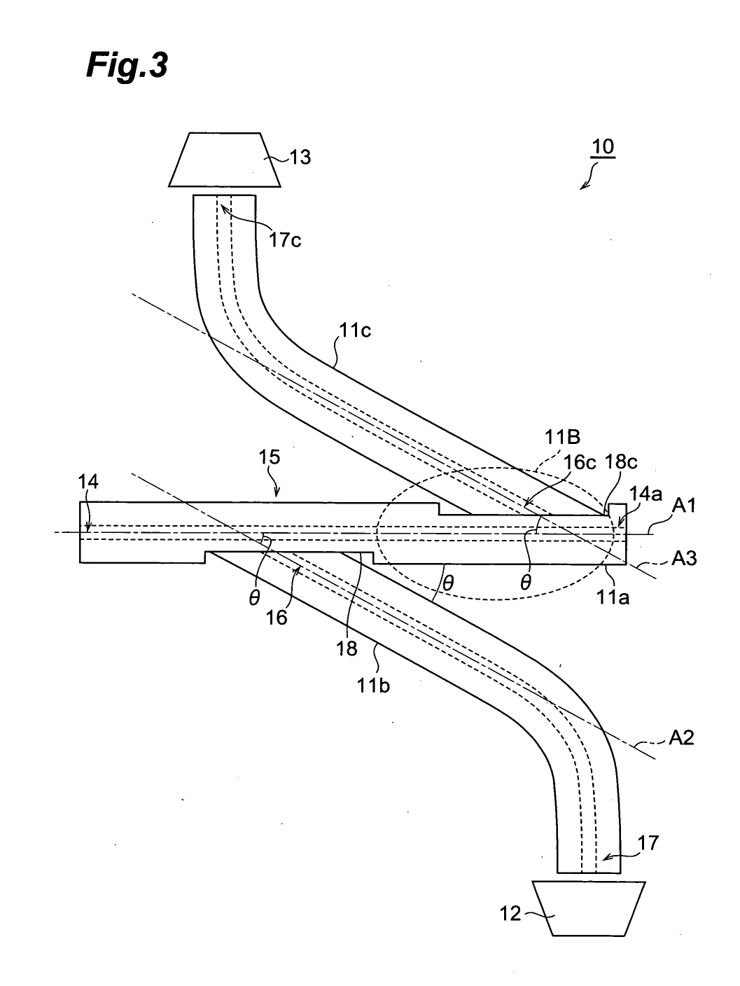

Alternatively, the photodetection device 10 according to this embodiment may be constituted as shown in FIG. 3. FIG. 3 is a side view showing another constitutional example of the photodetection device 10 according to this embodiment. In the constitution shown in the drawing, an optical fiber coupler 11B is formed by coupling the end face of the third optical fiber 11c to the side face 18c of the first optical fiber 11a. More specifically, in the optical fiber coupler 11B, a part of the side face 18cof the first optical fiber 11a is polished flat while the end face of the third optical fiber 11c is polished to a diagonal, whereupon the diagonally-polished end face of the third optical fiber 11c is optically coupled to the flat portion on the polished side face 18c of the first optical fiber 11a. The coupling method employed at this time may be adhesion using a resin or fusion through arc discharge or laser heating. The third optical fiber 11c is provided between the second end 14a of the first optical fiber 11a and the second optical fiber 11b. Therefore, the reflected light of the photodetector 12 doesn't get to the photodetector 13. The photodetector 13 is optically coupled to a first end 17c of the third optical fiber 11c. A second end 16c of the third optical fiber 11c is optically coupled to the first optical fiber 11a.

In this case, an angle θ formed by the optical axis A1 of the first optical fiber 11a and the optical axis A3 of the third optical fiber 11c is preferably held to or within a radiation angle corresponding to the NA of the first optical fiber 11a. When the NA of the first optical fiber 11a is 0.06, the angle θ is preferably held to or within ±6.9°. However, when the angle θ is 6.9° or smaller, coupling, including polishing of the third optical fiber 11c, becomes difficult.

The present invention is not limited to the embodiment described above, and may be subjected to various modifications. For example, FIG. 2 illustrates a constitution for monitoring light output from the light source 20, but by coupling the second optical fiber 11b to the first optical fiber 11a at an opposite angle, the light (reflection light or thermal radiation) that is generated upon irradiation of the processing subject 2 with the laser light can be monitored.

According to the present invention as described above, optical power can be monitored with a greater degree of accuracy even when a light source module is used in a processing application or the like.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A photodetection device comprising:
a photodetector having detection sensitivity at a first wavelength;
a first optical fiber propagating light in a plurality of modes at the first wavelength, the first optical fiber having an entrance end on which light at the first wavelength falls; and
a second optical fiber propagating light in a plurality of modes at the first wavelength, the second optical fiber having a product of a core diameter and a numerical aperture at the first wavelength that is greater than a product of a core diameter and a numerical aperture at the first wavelength of said first optical fiber, the second optical fiber having one end and another end, the second optical fiber being optically coupled to said first optical fiber at the middle of said first optical fiber in a longitudinal direction of said first optical fiber, and the one end of the second optical fiber being optically coupled to said photodetector.

2. The photodetection device according to claim 1,
wherein said first optical fiber and said second optical fiber are optically coupled through fusion, and
wherein an optical axis of said first optical fiber is essentially parallel to an optical axis of said second optical fiber at the connection point between said first optical fiber and said second optical fiber.

3. The photodetection device according to claim 1,
wherein the another end of said second optical fiber is optically coupled to a side face of said first optical fiber by a resin.

4. The photodetection device according to claim 3,
wherein the side face of said first optical fiber is flat, and
wherein an angle formed by an optical axis of said first optical fiber and an optical axis of said second optical fiber is not more than 6.9°.

5. The photodetection device according to claim 1,
wherein the core diameter of said first optical fiber is at least 15 μm, and
wherein the relative refractive index difference between the core and cladding is not more than 0.08%.

6. A light source module comprising:
the photodetection device according to claim 1; and
a light source for emitting light of the first wavelength to the entrance end of said first optical fiber,
wherein the entrance end optically opposes the one end of said second optical fiber via the connection point between said first optical fiber and said second optical fiber.

7. The light source module according to claim 6,
wherein said light source is a fiber laser light source comprising an amplification optical fiber as an optical amplification medium, and the optical waveguide extending from the amplification optical fiber to said first optical fiber is constituted so as not to comprise a spatial coupling component.

8. The light source module according to claim 6, further comprising another photodetector having detection sensitivity at the first wavelength, the another photodetector being optically coupled to said first optical fiber.
